(19) United States
(12) Patent Application Publication
(10) Pub. No.: US 2018/0321950 A1
(43) Pub. Date: Nov. 8, 2018

(54) Information Handling System Adaptive Action for User Selected Content

(71) Applicant: Dell Products L.P., Round Rock, TX (US)

(72) Inventors: Sathish K. Bikumala, Round Rock, TX (US); Fernando L. Guerrero, Austin, TX (US); Danilo O. Tan, Austin, TX (US)

(73) Assignee: Dell Products L.P., Round Rock, TX (US)

(21) Appl. No.: 15/586,794

(22) Filed: May 4, 2017

(51) Int. Cl. G06F 9/44; G06F 3/0488; G06F 3/0481

(52) U.S. Cl. CPC G06F 9/4443; G06K 9/18; G06F 3/04817; G06F 3/04886

(57) ABSTRACT

An information handling system having a touchscreen display desktop workspace adapts to supplement actions selected by an end user through touches for more rapid and simple touch control. Actions monitored at the information handling system are used to build task profiles that correlate subsequent actions and information processed by the actions. The task profiles are then referenced to complete an action detected at the information handling system without additional end user inputs. In one embodiment, the action is power up of the information handling system and the task profile is initiation of applications used at power up by the end user. In an alternative embodiment where an action is associated with multiple task profiles, icons are presented for selection by an end user of the task profile to perform.

### CROSS REFERENCE TO RELATED APPLICATION

U.S. patent application Ser. No. ______, entitled “Information Handling System Adaptive and Automatic Workspace Creation and Restoration” by inventors Sathish K. Bikurnala and Fernando L. Guerrero, Attorney Docket No. DC-108264.01, filed on even date herewith, describes exemplary methods and systems and is incorporated by reference in its entirety.

### BACKGROUND OF THE INVENTION

### Field of the Invention

The present invention relates in general to the field of information handling system application management, and more particularly to an information handling system adaptive action for user selected content.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often interact with end users through a touchscreen display. Generally, the operating system or applications running over the operating system present a user interface with graphical input buttons that the end user presses to perform actions. At an operating system level, general input devices are presented to accept end user touches, such as a keyboard that accepts key touches as inputs made at graphical keys. Applications may use underlying operating system input user interfaces and/or may also present application-specific touch buttons that accept touches with defined inputs. In some instances, applications apply touches to generate images, such as handwritten or hand drawn images. Generally, graphical input devices mimic physical peripherals, such as a keyboard and a mouse, that also interface with the information handling system, such as through a cabled or wireless interface.

Tablet information handling systems have a planar housing footprint that typically uses a touchscreen display as the only integrated input device. Generally the planar housing footprint offers a small relative size that enhances portability, such as with smartphone and other handheld devices. In most use cases, end users tend to consume information with tablet portable information handling systems, such as by browsing the Internet or reading mails, and create information with larger information handling systems, such as desktops or laptops that have physical peripheral input devices. Although touchscreen displays will accept complex information inputs, end users typically find that interacting only through a touchscreen display is more difficult and time consuming than operating through physical peripherals. For example, end users tend to have greater efficiency typing inputs at a keyboard that has physical keys than at a displayed keyboard that does not offer a physical feedback after an input. Generally, end user needs are met with tablet information handling systems since end users do not typically use portable information handling systems in a mobile environment by creating detailed content. Generally, if end users intend to create content with a portable information handling system, end users interface a peripheral input device, such as a keyboard.

As touchscreen displays have advanced in performance and decreased in cost, end users have adopted desktop touchscreen displays horizontally-disposed as interactive input devices. A touchscreen display on a desktop surface operates as a virtual peripheral by presenting images of a keyboard or other input device that an end user interacts with. A large touchscreen display provides a convenient drawing surface that accepts drawn or written inputs, and also offers an interactive surface for engaging with content using totems or other devices. Although a horizontally-disposed touchscreen display offers a unique and interactive input device, it consumes desktop space and often takes on duty as the end user's primary input device. In that respect, a horizontally-disposed touchscreen suffers from many of the same shortcomings of tablet information handling systems. For example, starting and setting up applications can take more time through a touchscreen display than through physical peripheral devices like a keyboard and mouse. Once applications are executing, inputting information by using a virtual keyboard and touches tends to consume display space so that content is compressed or hidden. Yet if an end user relies upon physical peripherals to interact with an information handling system, transitioning between the physical peripherals and the touchscreen interactive environment tends to introduce confusion and delay before the end user engages with content.

### SUMMARY OF THE INVENTION

Therefore, a need has arisen for a system and method which provide an adaptive and automatic workspace creation and restoration.

A further need exists to offer automated actions for end users based upon selected content and media.

In accordance with the present invention, a system and method are provided which substantially reduce the disadvantages and problems associated with previous methods and systems for establishing and restoring end user interactions with applications at an information handling system. Actions detected at an information handling system are tracked, correlated with applications, and stored as task profiles. As actions are detected, they are compared with existing task profiles to provided automated configuration of applications executing on the information handling system. In one embodiment, a task profile defines actions that include initiation of applications at power up of the information handling system based on tracking of end user interactions with the information handling system. In an alternative embodiment, task profiles are represented by icons presented in order of priority as selectable options for the end user in response to actions detected at the information handling system

More specifically, an information handling system processes information with a processor and memory to present information as visual images at one or more displays. A desktop environment presents visual images at a horizontally-disposed touchscreen display that accepts end user touches as inputs. The touchscreen display includes an open configuration user interface having a ribbon of prioritized icons that perform actions at the information handling system. An application tracker executing over the operating system of the information handling system tracks applications associated with actions performed at the information handling system and builds task profiles that correlate actions and applications with outcomes predicted as desired by the end user based upon detected actions. As actions are detected, existing task profiles are compared with the actions to determine if actions defined by the task profile should be performed. In one embodiment, task profile actions are automatically performed, such as at power up of an information handling system. Alternatively, task profiles associated with an action are presented in a prioritized list selectable by the end user. As an example of task profiles, an action of highlighting information with a touch at a horizontally-disposed touchscreen display provides three task profiles: a first for text, a second for ink images, and a third for graphic images. On detection of a highlighting action, an application initiator, such as a state machine in the operating system, analyzes the highlighted information hand provides an end user with selectable icons for operating on the highlighted information.

The present invention provides a number of important technical advantages. One example of an important technical advantage is that an end user has interaction with a desktop horizontally-disposed display supplemented by prediction of applications and information to apply in response to actions detected at the information handling system. Touch interactions tend to take more time and care for end users than interactions with physical input devices, such as a keyboard and mouse. Task profiles built over time based upon end user actions automates all or part of the tasks that the end user performs through the touchscreen environment so that the end user accomplishes desired tasks more quickly and accurately with fewer inputs. As actions are detected at the information handling system, the actions are compared with task profiles so that subsequent actions are predicted, such as with macros that associate initiation and/or use of applications with a detected action. In some instances, task profiles command automatic performance of processing tasks. In alternative embodiments, prioritized lists of task profiles are generated and presented as selectable icons as actions are detected. In one embodiment, task profiles apply differently with touch inputs than with inputs using physical devices, such as a keyboard or mouse. For example, task profiles may be applied only to actions associated with touch inputs so that an end user has touch inputs supplemented with task profile actions while more efficient input devices do not have interference related to automated processing.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system desktop environment having adaptive and automated task profile creation and restoration;

FIG. 2 depicts a block diagram of an information handling system supporting adaptive and automated task profile creation and restoration;

FIG. 3 depicts a state diagram of action responses defined by task profiles;

FIG. 4 depicts a flow diagram of a process for action responses defined by task profiles;

FIG. 5 depicts a flow diagram of a process of action responses initiated from an end user press;

FIG. 6 depicts a flow diagram of a process for defining a task profile with a macro to accomplish the task;

FIG. 7 depicts a flow diagram of a process for naming task profile macros;

FIG. 8 depicts a flow diagram of a process for defining a graphical icon to accept end user inputs of an action initiation; and

FIG. 9 depicts a flow diagram of a process for presenting a task profile initiation icon to an end user.

### DETAILED DESCRIPTION

Information handling system end user interactions adapt in an automated fashion based upon detected actions so that graphical touchscreen displays provide timely and intended responses with reduced end user inputs. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a key board, a mouse, and a video display. The information handling system may also include one or more buses operable to transmit communications between the various hardware components.

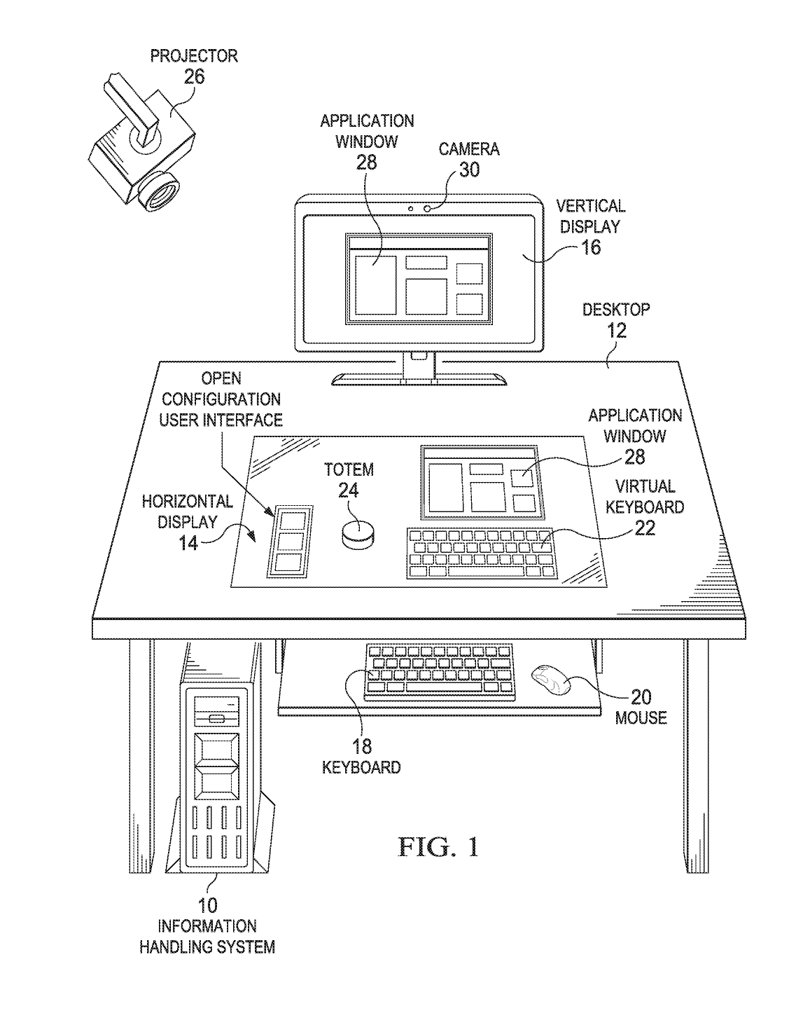

Referring now to FIG. 1, an information handling system 10 desktop 12 environment having adaptive and automated task profile creation and restoration is depicted. Information handling system 10 processes information, such as by executing applications over an operating system, and presents information as visual images at display devices, such as horizontal touchscreen display 14 disposed on desktop 12 and a vertical display 16 standing on desktop 12. In one alternative embodiment, a projector 26 display device presents information as visual images at desktop 12 and a camera 30 tracks end user movements to accept inputs based upon analysis of visual images captured by the camera. End users make inputs to information handling system 10 through a variety of input devices including with touches at horizontal display 12, through a physical keyboard 18 and through a physical mouse 20. In the example embodiment, a virtual keyboard 22 is presented on touchscreen display 14 to accept touches as typed inputs to keys. A totem 24 rests on display 14 to transfer touches that provide inputs based upon a user interface presented on display 14.

Information handling system 10 manages input and output of information through an operating system that supports execution of applications. Applications present information in application windows 28 presented on displays 14 and 16. An end user selects an application window 28 to be an active application so that inputs made through input devices are directed to the active application. In various user environments, open applications can create a complex work environment that allows an end user to process information with different applications and transfer the information between the different applications. Multi-tasking allows an end user to simultaneously run multiple applications with unrelated tasks so that the end user can quickly shift between tasks while information is maintained active in the background. Often in an enterprise environment, end users have specific functions assigned to them so that their information processing is focused on desired objectives, outcomes and tasks that use capabilities spread across multiple applications. As a result, end users often follow a startup routine to open and execute multiple applications simultaneously. For example, a software designed might open a photoshop application, a source control repository, an IDE, a browser, test clients like a SOAP UI, plus non-task specific applications like email and messaging. A similar end user pattern is followed in non-enterprise use cases. For example, a college student working on a thesis might open word processing, presentation, web browsing, image editing, email, messaging and library applications. During a workday, end users will often interact across multiple applications by copying, cutting and pasting information to generate work product. Where an end user relies upon touch inputs through a horizontal display 14 to manage application interactions and sharing of information, the touches involved sometimes introduce inefficiencies.

In order to improve end user interactions through a horizontal display 14, an open configuration user interface 31 is presented on display 14 to supplement actions based on anticipated task profiles. In the example embodiment, open configuration user interface 31 is a ribbon of icons that an end user may select to initiate an action. In some instances, automated actions are initiated based upon detected inputs and predicted actions. For example, information handling system 10 at start and at each input automatically predicts what outcome a user intends to work on with applications and in response automatically opens and populates the applications with relevant information. Task profiles are generated based upon the open applications and detected inputs at application windows 28 so that information is presented at displays in a manner predicted as desired by the end user. Task profiles are automatically generated over time by monitoring end user interactions and leveraging machine learning to create correlations between applications and information types based upon previous usage patterns, such as by watching information movement through clipboard content or other transfers between applications, and by watching to and from application transitions, and by watching how an end user lays out application windows 28 with different types of interactions. Application execution to achieve detected repetitive behavior or an end user is saved as task profiles in application configurations and represented by an icon selectable by an end user. In this manner, an end user selection of an icon from open configuration user interface 31 prepares the desktop environment to perform a task profile associated with the icon selection, saving the end user time associated with looking for applications and information needed to accomplish a task and opening application windows 28 configured to perform the task. Further, once a task profile is automatically generated, the workspace may be readily re-created if necessary. For example, task profiles automatically generated on information handling system 10 are saved to a network location and recalled based on a user identifier so that the workspace environment translates to other information handling systems that the user signs into. In one embodiment, task profiles are applied for actions made at a horizontal display 14 but actions associated with vertical display 16 or physical input device like keyboard 18 or mouse 20 are ignored. Thus end user interactions are supplemented with automatic application initiation for touchscreen devices where end user inputs take more time while an end user engaged in rapid inputs through a keyboard and mouse is not slowed by automated processing.

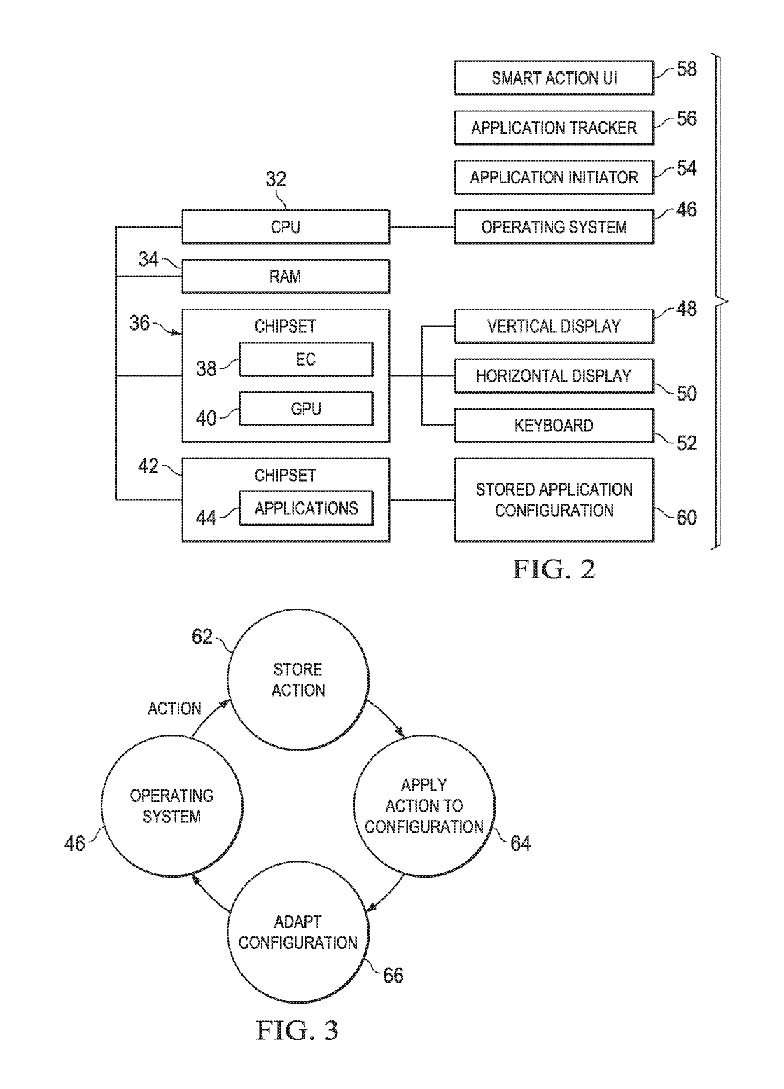

Referring now to FIG. 2, a block diagram depicts an information handling system 10 supporting adaptive and automated task profile creation and restoration. A central processing unit (CPU) 32 executes instructions that process information stored in random access memory (RAM) 34. A chipset of plural processing and memory devices coordinates communication of information, such as for interacting with input and output devices. In the example embodiment, chipset 36 includes an embedded controller 38 that manages power and inputs from peripheral devices, such as key inputs from a keyboard 52 and touch inputs from a touchscreen display like horizontal display 50. A graphics processor unit (GPU) 40 processes information to generate pixel values that define visual images presented at displays 48 and 50. A solid state drive (SSD) 42 or other persistent memory device stores information and applications accessed by CPU 32. In the example embodiment, stored application configurations 60 saved in association with applications 44 define relationships of task profiles that CPU 32 references to generate open configuration user interface 31.

In the example embodiment, CPU 32 executes an operating system 46 to manage interactions with other applications. In order to automate the desktop environment, an application initiator 54 running over operating system 32 automatically initiates applications for an end user based upon task profiles associated with detected end user actions. Application initiator 54 establishes an end user predicted desktop environments based upon actions detected in the environment, such as inputs by an end user or receipt of information from application processing or a network resource. As an example, application initiator generates a workspace environment automatically at startup of information handling system 10 with applications and information selected based upon a task profile. An application tracker 56 monitors applications selected by an end user for active or background uses. For example, application tracker 56 tracks the order of selection of active applications to correlate relationships between the applications, such as based upon the type of information being used and the totality of applications open in the workspace. A smart action user interface 58 applies the open applications and the historical tracking of active applications to initiate automated actions and/or provide the end user with selectable actions that accomplish predicted task profiles. As actions are detected, stored application configurations 60 are applied to perform partial or complete task profile actions. As an example, application tracer 54 detects an email in an active window that includes reference to a meeting. In response, a task profile that associates entails with scheduling information to a calendar application presents an icon at smart action user interface 58 that allows the end user to populate a calendar event with a single touch by copying the email scheduling information into a calendar event.

Smart action user interface 58 provides an end user with a clickable button to take an action based upon task profiles detected at an information handling system that do not indicate an automated action. For example, selection by an end user of text or media with a touch at a horizontal display 14 is detected as an action and associated with a task profile presented as a selectable option to the user through a smart action user interface 58, such as at the open configuration user interface 31. As an example, handwritten content created with a stylus touch to horizontal display 14 is automatically converted to text with OCR and in a format acceptable to open applications so that an end user touch applies the text to the intended application without the user performing additional inputs. As another example, an end user touch at text content on display 14 highlights the text and generates one or more icons for smart user action user interface 58 to allow the end user to select an application that will perform an action with the text. In one embodiment, the end user may select an icon at smart action user interface 58 before highlight the text so that at completion of the highlighting of the text the information is ready to use. For instance, highlighting an email address followed by selection of an action icon will populate an email with the address. Similarly, selection of an email action icon followed by highlighting of a name in a word processing document will cause a lookup of the name in an address book followed by population of an email with the address book email address associated with the name. After several repetitions of the action are detected, an automated response is created for highlighting of names in word processing documents so that emails are populated with addresses without further inputs by an end user. As another example, highlighting of an image on display 14 generates smart action user interface icons to perform actions on the image based upon the image type and applications that operate on the type of image. Alternatively, an end user may select an action before highlighting an image to help ensure that a desired application manages the image once the image is highlighted.

Referring now to FIG. 3, a state diagram depicts action responses defined by task profiles. The operating system maintains a monitoring state to monitors inputs made at horizontal display 14. For example, the application initiator is embodied in executable code associated with the operating system and executing as a state matching. Upon detection of an action at horizontal display 14, the state transitions to store the action at step 62. Storing actions provides a database over time that allows correlation between actions, applications and information types so that task profiles are generated and updated based upon the database. At step 64, the detected action is applied to set a configuration based upon task profiles associated with the action. For example, if the task profile for a detected action involves an automated interaction with an application, the automated interaction is performed and the result displayed. As another example, if the task profile includes interactions with two or more possible applications, an icon is presented for each interaction so that the user may select which action to take. At step 66, the detected action is applied to adapt configuration settings by defining new task profiles where appropriate. For example, end user interactions with an automated action are monitored so that task profiles more accurately correlate with intended user inputs based upon actual user actions.

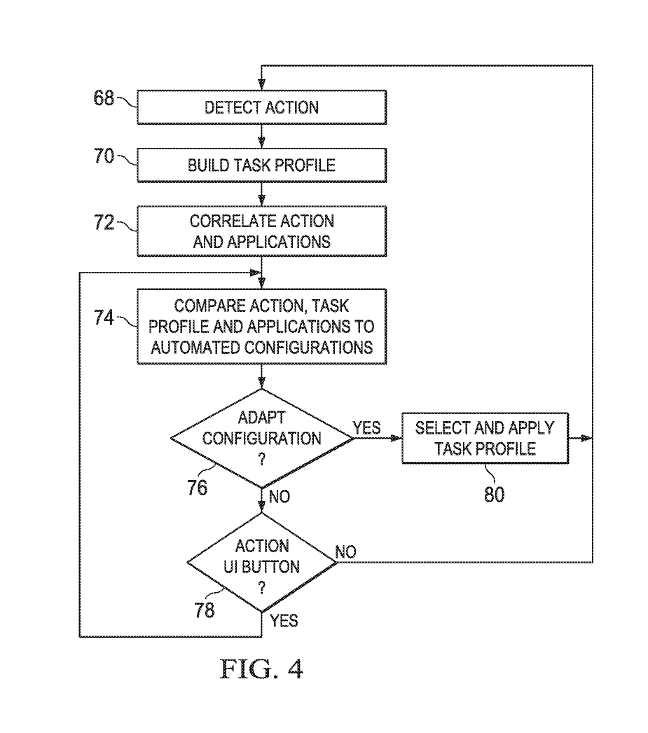

Referring now to FIG. 4, a flow diagram depicts a process for action responses defined by task profiles. The process starts at step 68 with detection of an action, such as an input by end user or communication received through a network. At step 70, one or more task profiles are built in response to the action detection. The task profile may represent an automated response to the action where a high confidence exists for end user preferences or may represent several possible tasks aligned with the detected action. For example, detection of a highlight of an email address in a word processing document may automatically initiate an email application to prepare an email with the address, may initiate a smart action icon to launch the email application with the email address or may initiate multiple smart action icons, such as one icon to launch an email application and another to launch and address book. At step 72, the detected action is correlated with open and accessible applications to discern task profiles that are applicable and the priority of the task profiles. For example, if a number of short term actions have involved a text transfer between two applications, that task profile will have a higher priority than other task profiles that are used less often. At step 74, the action, task profiles and applications are compared with automated configurations to identify any automated configuration changes associated with the action. For example, an automated configuration change would adapt the applications running on the information handling system and their presentation in application windows in order to less the burden on an end user of interacting through the touchscreen. In one embodiment, automated configurations may be employed where an end user is interacting through a touchscreen and may be skipped where an end user is interacting through physical peripheral devices, like a keyboard. At step 76, a determination is made of whether to automatically adapt a configuration to perform a task profile responsive to the detected action. If so, the process continues to step 80 to select and apply the task profile. If automated configuration is not determined at step 76, the process continues to step 78 to present one or more action user interface button icons for an end user to select. For example, a ribbon of action buttons populate and unpopulate as an end user performs actions to provide the end user with options for adapting the touchscreen desktop environment with automated application initiation and information transfer between the applications while reducing inputs called for from an end user to accomplish desired tasks.

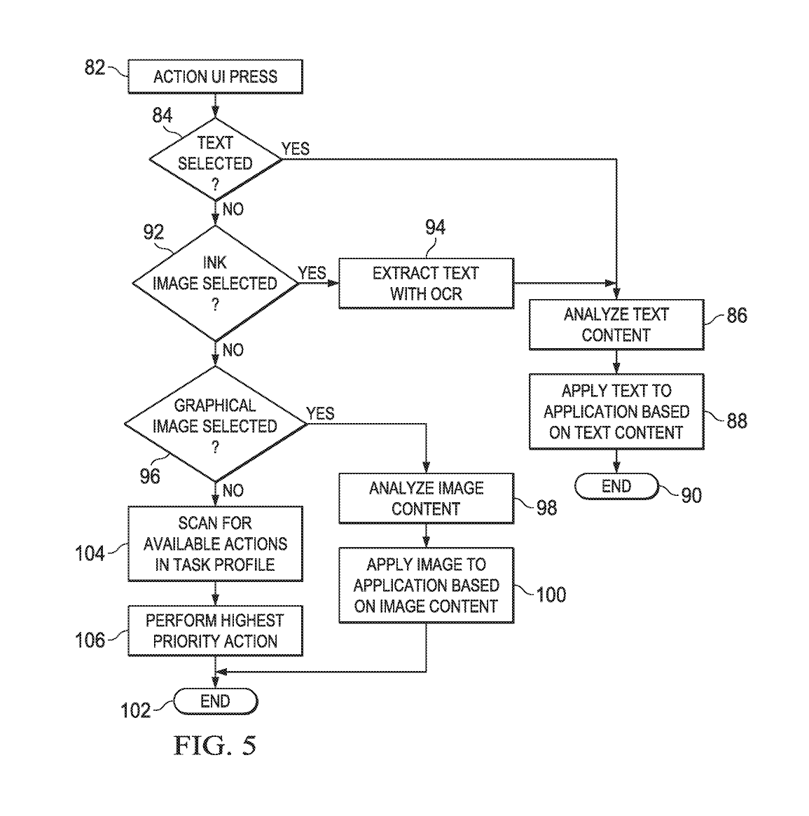

Referring now to FIG. 5, a flow diagram depicts a process for action responses initiated from an end user press. In the example embodiment, task profiles aid management of copy and paste operations in a touchscreen environment. Generally, text or content is copied onto a clipboard with a tab-and-hold function on a touchscreen display, and then the end user manually selects an application to use the clipboard information. By recognizing patterns in the copying and pasting of content, task profiles dynamically show suggestions for the use of copied content based on the patterns. For example, a user who copies a phone number (or email address) might use that phone number in a variety of different applications based upon a context at the information handling system. For instance, the user might use the phone number for an SMS text, a Skype call, an address book modification or in a document. The use of the phone number becomes predictable by monitoring user interactions over time so that an action preceding the copying of the phone number indicates how the phone number will be used in a pasted subsequent application or applications. Task profiles reflect end user interactions so that combined actions are presented as selectable icons that a user leverages for more efficient interactions in a touchscreen environment. That is, by combining recognition of patterns in clipboard content with awareness of context of the application that provided the content, historical end user interactions, temporal interactions that indicate how recently applications were applied and applications open at an information handling system, task profiles provide relevant application selection options that reduce touch inputs required of the end user at the touchscreen. For example, task profiles suggested to an end user are prioritized on presentation. For instance, with the telephone number example, if a phone number pattern type is copied into a sales application, a sales order number is recognized as the user of the phone number and a task profile icon is presented that, if selected, initiates a sales order search of a related database or website. Other similar embodiments apply task profiles to different types of text patterns, such as email addresses, URLs, parts numbers, etc. . . . , to offer an end user task profile icon options for more efficient touchscreen interactions. In one example embodiment, analysis of graphical images suggests applications to paste the graphical images into. For instance, copying from a browser versus copying from an application suggests different applications to paste in the image based upon content, pattern and context analysis.

At step 82, an end user selects an action user interface button, such as from a list of icons of an open configuration user interface ribbon where the icons are generated responsive to detection of an action at the information handling system. At step 84, a determination is made of whether text is selected in a copy field on the user interface. If yes, the process continues to step 86 to analyze the text content, such as by looking for email addresses, names, Internet addresses, etc. At step 88, the text is applied to one or more applications that have a task profile associated with the text content. For example, if a task profile includes an automated action, the text is transferred to an appropriate application for the action to apply. If the task profile or plural task profiles do not include automated actions, then action user interfaces are presented at the horizontal display that the end user can select to initiate the action on the text. For example, if the highlighted text is an email address and the task profile reflects a series of emails sent by the user to copied email addresses, automated generation of an email is performed. If the end user has not demonstrated a definite action of sending an email, then task profiles may generate user action icons for the copied email address, such as an icon to start an email to the address, an icon to start an address book add for the address, etc. . . . The user then selects the action icon as appropriate to perform the desired action. The process ends at step 90.

If at step 84 the highlighted information is not text, the process continues to step 92 to determine if the highlighted information is an ink image, such as a handwritten text performed with a finger or stylus. If an ink image is determined, the process continues to step 94 to translate the ink image to text with OCR or other appropriate means. Once the ink image translates to text, the process continues to step 86 to manage the task profiles based upon a text analysis. If at step 92 the highlighted image is not an ink image, the process continues to step 96 to determine if a graphical image is detected, such as a picture, video icon or other type of image. If yes, the process continues to step 98 to analyze the image content, such as with an analysis of the type of file and/or an image recognition analysis of the image content. At step 100, the image is applied to one or more applications based upon the image analysis, such as by execution of an automated action or generation of action icons that perform actions associated with task profiles upon selection by an end user. For example, a graphical image that is selected in a series of actions, such as to paste into a slideshow, automatically gets pasted into the slideshow. Alternatively, an action icon is generated for each application that might use the graphical image with the action icons listed in priority from the most likely to least likely action. End user selection of the action icon applies the graphical image to the application to perform the action. In one embodiment after selection of an action icon, the remaining action icons are removed. Alternatively, action icons are removed when a subsequent end user action indicates that the action icons are not relevant. If the highlighted information is not determined to be a graphical image at step 96, the process continues to step 104 to scan for other available actions in task profiles that might be associated with the highlighted information, and at step 106 the highest priority action is performed if appropriate. In one embodiment, the process for action responses of FIG. 5 is performed for information highlighted on horizontal displays and not vertical displays. Alternatively, the process is performed when highlighting is done by a touch but not by a mouse. Thus, for example, end user interactivity with a horizontal display device is enhanced while end user interactions that relay on more precise inputs devices, such as a mouse, do not initiate automated actions.

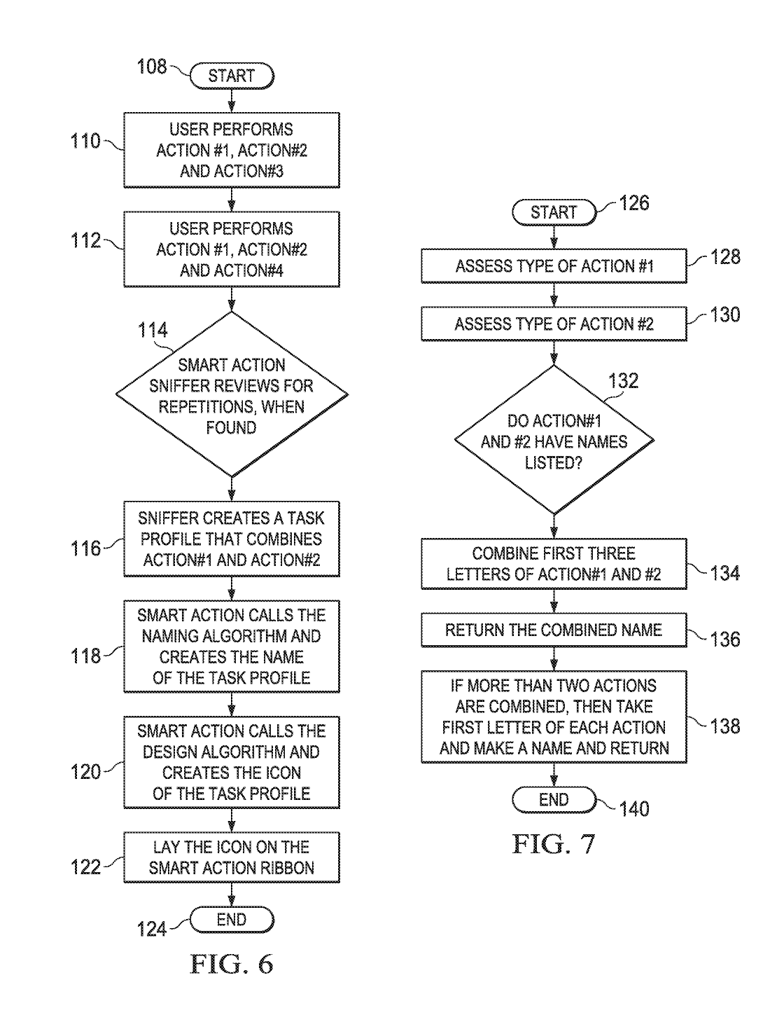

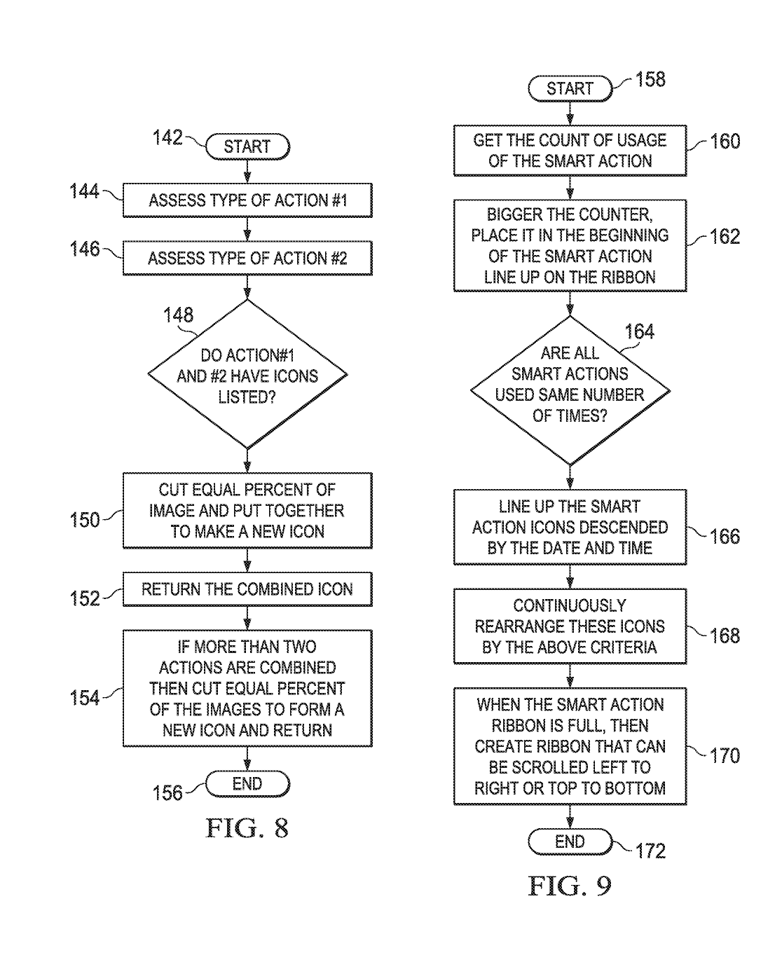

Referring now to FIG. 6, a flow diagram depicts a process for defining a task profile with a macro to accomplish the task. The process starts at step 108, such as by monitoring inputs at an operating system with a state machine, and continues to steps 110 and 112 to detect inputs associated with actions 1-4. At step 114 a smart action “sniffer” reviews detected actions for repetitions and/or patterns. The sniffer analyzes actions at an application level and uses the actions to associate the applications in a manner that ultimately creates a task profile. In the example, actions 1 and 2 are repeated, however in one instance actions 1 and 2 combine with action 3 while in another instance actions 1 and 2 combine with action 4. Based upon the repetition of actions 1 and 2, at step 116 a task profile macro is created that upon execution performs actions 1 and 2. At step 118, the task profile macro is named as described in greater depth by FIG. 7, and at step 120 an icon is designed for the task profile macro as described in greater depth by FIG. 8. At step 122, the icon is placed on the horizontal display for an end user to select. In alternative embodiments, the task profile macro is saved in association with one or more task profiles and selectively presented if a task profile is detected based upon end user actions.

Referring now to FIG. 7, a flow diagram depicts a process for naming task profile macros. The process starts at step 126 upon creation of a new task profile macro and, at steps 128 and 130 the types of actions associated with the macro are assessed. At step 32, a determination is made of whether the actions have names associated with them and, at step 134 the letters used in the names are combined to generate a unique name for the macro. At step 136 the name is returned for reference by task profiles and other actions. At step 138, more complex names may be created for macros that combine additional actions, such as by combing letters of the additional actions or applications. The process ends at step 140. In alternative embodiments alternative naming conventions may be used.

Referring now to FIG. 8, a flow diagram depicts a process for defining a graphical icon to accept end user inputs of an action initiation/ The process starts at step 142 and at steps 144 and 146 the types of actions associated with the macros are assessed. At step 146 a determination is made of whether the detected actions already have icons, such as might be defined for applications or other existing combined macros. At step 150, the icons for the actions are cut and combined to create a unique icon for the macro that combines the actions and, at step 152, the combined icon is returned to relate with task profiles associated with the macro. For instance, in the example embodiment a task profile created for actions 1, 2 and 3 and for actions 1, 2 and 4 will each relate to the macro defined for actions 1 and 2. At step 154 multiple-action icon creation is supported so that each macro has a unique appearance, and the process completes at step 156.

Referring now to FIG. 9, a flow diagram depicts a process for presenting a task profile initiation icon to an end user. The process starts at step 158 and continues to step 160 to count the usage of a defined macro, such as the number of times the macro and/or its defined actions are selected by the end user in a defined time period. At step 162, icons for defined and relevant macro actions are presented in a priority order based upon the count for each icon. In one embodiment, icons may be selectively presented based upon relevance to sensed task profiles. For example, as actions are detected at an information handling system, such as with end user inputs, application events and/or information communicated from a network, the relevance of the actions to available macros causes relevant macro icons to be presented. At step 164 a determination is made of whether smart action icons have a similar priority, such as where two macros have a similar or identical number of uses. If so, at step 166 the icon presentation order the gives priority to icons selected at a more recent time. At step 168, macro icons are rearranged as conditions change so that relevant action icons are presented to the user in priority based upon actions, events and information at the information handling system. At step 170, if the display area allocated to the action icons is full, icons having a lower priority may be minimized or hidden for selective presentation by an end user. The process ends at step 172.

Although the present invention has been described in detail, it should be understood that various changes, substitutions and alterations can be made hereto without departing from the spirit and scope of the invention as defined by the appended claims.

What is claimed is:

1. An information handling system comprising:
a processor operable to execute applications to process information;
a memory interfaced with the processor and operable to store the instructions and the information;
a horizontally-disposed touchscreen display interfaced with the processor and operable to present the information as visual images and to accept touch inputs; and
a smart action user interface presented at the horizontally-disposed touchscreen display and selectable by an end user touch, the smart action user interface initiating one or more applications in response to the end user touch, the one or more applications executing to process information identified on the horizontally-disposed touchscreen display.

2. The system of claim 1 wherein:
the information identified on the horizontally-disposed touchscreen display comprises information highlighted by an end user touch; and
the one or more applications comprises an application to analyze the highlighted information content.

3. The system of claim 2 wherein highlighted information comprises an image and the application converts the image to text.

4. The system of claim 2 wherein the information comprises a graphical image having a visual depiction and the application analyzes the graphical image to determine a second application to copy the graphical image into.

5. The system of claim 2 wherein the smart action user interface comprises plural icons, each icon initiating a different application, each of the different applications upon initiation by an associated icon inserting information highlighted on the horizontally-disposed touchscreen display into a document managed by the application.

6. The system of claim 5 wherein the smart action user interface selectively presents less than all of the plural icons so that each of the different applications has a relevance to the highlight information.

7. The system of claim 2 further comprising:
a vertical display interfaced with the processor and operable to present the information as visual images;
wherein the smart action user interface ignores information highlighted at the vertical display.

8. The system of claim 2 further comprising:
a physical mouse input device interfaced with the processor;
wherein the smart action user interface ignores highlighting related to inputs made at the physical mouse input device.

9. The system of claim 2 wherein the one or more applications comprises plural applications configured to execute as a macro.

10. A method for managing user selected information presented at apt information handling system display, the method comprising:
detecting user selection of information by an end user input performed at the information handling system;
analyzing the information at the information handling system to determine a type of content; and
based upon the type of content, presenting one or more icons with the information handling system, each icon initiating execution of one or more applications associated with the type of content.

11. The method of claim 10 further comprising:
detecting selection by an end user of the one or more icons; and
inserting the user-selected information into the application associated with the selected icon.

11. The method of claim 11 wherein analyzing the information further comprises converting graphical ink images to text.

13. The method of claim 10 wherein at least one icon is associated with execution of two or more applications, each of the two or more applications having a graphical icon image, the at least one icon having the graphical icon image of the two or more applications combined into a single graphical icon image.

14. The method of claim 10 further comprising:
monitoring actions at the information handling system;
detecting repetition of a first and second action associated with user selection of a predetermined type of content; and
automatically generating an icon to present at the information handling system to initiate upon selection of the icon the first and second actions for user selected information.

15. The method of claim 10 further comprising:
determining whether user selected information is presented at a horizontal display or a vertical display;
presenting the one or more icons only if the user selected information is presented at the horizontal display.

16. The method of claim 10 further comprising:
determining whether the user selected information was selected by a touch at a touchscreen or by an input through a peripheral device; and
presenting the one or more icons only if the user selected information was selected by a touch at a touchscreen.

17. The method of claim 10 wherein at least one of the one or more icons comprise one or more macros that execute plural applications upon selection of the at least one icon, the macro having a name derived from the plural applications.

18. The method of claim 10 wherein at least one of the icons automatically initiates one or more applications in the event the user selected information has a predetermined content type.

19. Non-transitory memory storing instructions that when executed on an information handling system cause:
detection of highlighting of information at a touchscreen display interfaced with the information handling system;
presentation of a first set of one or more icons if the highlighted information comprises text, each of the first set of icons initiating execution of an associated application that applies the text;
presentation of a second set of one or more icons if the highlighted information comprises a graphical ink image, each of the second set of icons initiating execution of an associated application that applies text generated from OCR analysis of the graphical ink image; and
presentation of a third set of one or more icons if the highlighted information comprises a graphical image, each of the third set of icons initiating execution of an associated application that applies the graphical image.

20. The instructions of claim 19 wherein the highlighting of information comprises touching of a horizontally-disposed touchscreen.
